(19) United States
(12) Patent Application Publication
(10) Pub. No.: US 2002/0021385 A1
(43) Pub. Date: Feb. 21, 2002

(54) Reflective screen lighting device

(75) Inventors: Koki Nakabayashi, Osaka (JP); Kenji Takamoto, Osaka (JP); Koji Hiramoto, Ishikawa-gun (JP); Shigeaki Sotsu, Ishikawa-gun (JP); Hideo Matsumoto, Osaka (JP)

Correspondence Address: Jordan and Hamburg, 122 East 42nd Street, New York, NY, 10168, US

(73) Assignee: MATSUSHITA ELECTRIC INDUSTRIAL CO., LTD

(21) Appl. No.: 09/837,441

(22) Filed: Apr. 17, 2001

(30) Foreign Application Priority Data
Apr. 18, 2000 (JP) 2000-116395
Jan. 30, 2001 (JP) 2001-21618

(51) Int. Cl. G02F 1/1335

(52) U.S. Cl. 349/65

(57) ABSTRACT

A reflective liquid crystal lighting device includes a light source, a tabular transparent light guide for receiving light emitted from the light source at a side surface and for emitting illuminating light from the back surface thereof, and a transparent material filled between the light guide and the reflective liquid crystal provided at the back side thereof. The reflective liquid crystal is viewed from the side of the front surface of the light guide through the transparent material.

### BACKGROUND OF THE INVENTION

1. Technical Field of the Invention

The present invention relates to a lighting device for reflective screens used in image displays.

2. Description of Related Art

Reflective liquid crystal has been increasingly employed in image displays for personal computers, mobile information terminals and portable video recorders in order to reduce the power consumption.

The reflective liquid crystal relies on ambient light such as sunlight and room light reflected thereon for its screen brightness. Enough brightness however cannot be secured at the screen in a place with little such outside light. Therefore, there has been proposed a reflective liquid crystal having a lighting device for illuminating the reflective liquid crystal when the outside light is scarce.

FIG. 10 shows a conventional reflective liquid crystal lighting device. In FIG. 10, reference numerals 21, 22, 23 and 24 represent a light source, a reflector, a light guide and reflective liquid crystal, respectively. The light guide 23 has grooves 25 formed in a stepped manner at the surface on the viewer's side. A transparent material 26 having a refractive index equivalent to that of the light guide 23 is filled between the light guide 23 and the reflective liquid crystal 24.

Light emitted from the light source 21 is guided through the light guide 23 and reflected by the stepped grooves 25 provided at the surface of the light guide 23 and illuminates the reflective liquid crystal 24. The viewer can see the reflective liquid crystal 24 through the light guide 23.

There is another known conventional example of such a device in which a back surface of the light guide 23 is provided with an anti-reflection film or diffusion treatment, and a transparent material 26 having a refractive index equivalent to that of the light guide 23 is filled between the light guide 23 and the reflective liquid crystal 24.

In the conventional reflective liquid crystal lighting device shown in FIG. 10, however, light guided through the light guide 23 directly reaches the reflective liquid crystal 24 and is diffused, so that equalized lighting cannot be provided. This is because the transparent material 26 having the refractive index equivalent to that of the light guide 23 is filled between the light guide 23 and the reflective liquid crystal 24.

When an anti-reflection film is provided at a back surface of the light guide 23, diagonal reflection of light degrades the visibility, particularly because the anti-reflection film does not function enough with respect to the light in diagonal directions, and because the transparent material increases the reflectance. If the back surface of the light guide 23 is provided with diffusion surface treatment, the visibility degrades because of scattering at the back surface, and no clear image results.

The back surface of the light guide 23 is typically entirely flat and hardly allows even filling with the transparent material 26, and irregularities could be caused at the screen.

When the transparent material 26 is filled, the material sometimes comes out from the space between the light guide and the reflective liquid crystal opposing each other. This could also cause irregularities on the screen.

Products to be marketed must be reliable in that they must be free from deformation or damages in high temperature and humid conditions. The conventional devices however have a light guide, thin films, a transparent material and reflective liquid crystal of different materials layered upon one another, and therefore differences between the thermal expansion coefficients of the materials could cause deformity which lowers the reliability.

Meanwhile, a light guide of a resin material could be easily damaged in the process of manufacture. The reflective liquid crystal is more expensive than the light guide is. Therefore, a light guide damaged in the manufacturing process may be replaced while the reflective liquid crystal may be re-used for reducing the manufacturing cost. In the conventional devices, however, the adhesion is too strong with certain kinds of materials used for the light guide, and the liquid crystal cannot be reused. Securing of the reliability as described above is hardly compatible with providing readiness for reuse.

### SUMMARY OF THE INVENTION

The present invention is directed to a solution to the above-described problems associated with the conventional devices. It is an object of the present invention to provide a highly reliable, reflective screen lighting device which allows high picture quality and equalized lighting performance to be achieved at the same time, is free from irregularities caused by uneven filling or over filling of a transparent material and enables the reuse of reflective liquid crystal.

A reflective screen lighting device according to the present invention includes a light source, a tabular, transparent light guide for receiving light emitted-from the light source at a side surface thereof and for emitting illuminating light from a back surface thereof, and a transparent material filled between the light guide and a reflective liquid crystal provided on the back surface side of the light guide. Since the transparent material is filled between the light guide and the reflective liquid crystal, there is no light reflected from the front surface of the reflective liquid crystal, in other words there is no reflected light from the viewing side. This allows the screen to be clearly observed. The light guide has a generally tabular shape, and therefore the quantity of light guided through the light guide and directly reaching the reflective liquid crystal is reduced, so that equalized lighting can be achieved.

Grooves are formed at the front surface of the light guide. The grooves have a first inclined surface on the side closer to the light source and a second inclined surface on the side further from the light source. A flat surface may be formed between the grooves.

The depth of the grooves having these first and second inclined surfaces may be increased as the distance from the light source increases, or the interval between the grooves may be reduced as the distance from the light source increases. Alternatively, the distance between the front and back surfaces of the light guide may be reduced as the distance from the light source increases. Thus, uniform lighting is achieved over the entire surface of the lighting device.

The nature, principle, and utility of the invention will become more apparent from the following detailed description when read in conjunction with the accompanying drawings.

### BRIEF DESCRIPTION OF THE DRAWINGS

FIG. 1 is a side view of a reflective screen lighting device according to a first embodiment of the present invention;

FIGS. 2A to 2C are schematic views of various groove shapes at the front surface of a light guide according to the first embodiment;

FIGS. 3A to 3C are schematic views of various groove shapes in another example according to the embodiment;

FIG. 4 is a schematic view of an example of a reflection surface of reflective liquid crystal according to the embodiment;

FIG. 5 is a side view of a reflective screen lighting device according to a second embodiment of the present invention;

FIG. 6A is a bottom view of the light guide according to the embodiment;

FIG. 6B is a longitudinal section of the light guide;

FIG. 7 is a graph representing ideal reflectance for a thin film at the back surface of the light guide according to the embodiment;

FIG. 8 is a graph representing the reflectance at the back surface of the light guide made of a transparent material with a low refractive index according to the embodiment;

FIGS. 9A to 9G are graphs representing the reflectance at the back surface of the light guide according to various examples of the thin film according to the embodiment; and

FIG. 10 is a side view of a conventional reflective liquid crystal lighting device.

### DETAILED DESCRIPTION OF THE PREFERRED EMBODIMENTS

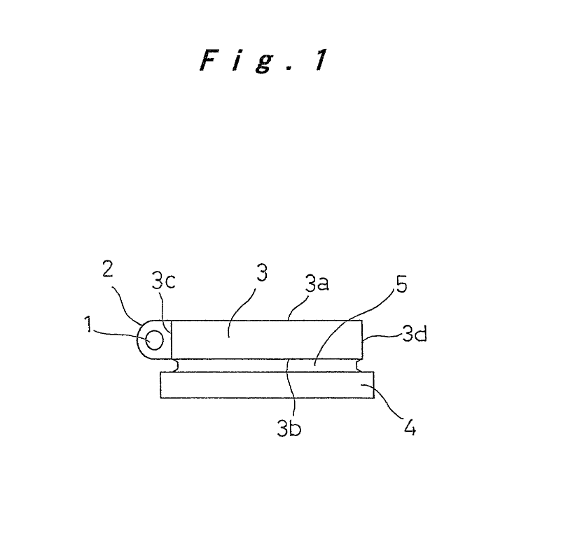

A reflective screen lighting device according to a first embodiment of the present invention embodied as a reflective liquid crystal lighting device will be hereinafter described with reference to FIGS. 1 to 4.

In FIG. 1, a light source 1 may be a fluorescent lamp such as a hot cathode tube and a cold cathode tube, an arrangement of multiple light emitting diodes, an incandescent lamp, or an organic light emitting substance arranged in a linear shape. The light source 1 is provided at a side surface of a tabular light guide 3.

A reflector 2 is provided to cover the light source 1 and has high reflectance and low diffusiveness at the inner surface. For example, a high-reflectance material such as Ag (silver) and Al (aluminum) is vapor-deposited on a resin sheet and the sheet is adhered to a thin metal plate or a resin sheet.

When the light source 1 is a fluorescent lamp, the gap between the light source 1 and the reflector 2 is desirably filled with a transparent material. The thickness of the light guide 3 at the side surface on the side of the light source 1 and the height of the reflector 2 are desirably equal. When the light source 1 is a light emitting diode whose radiation distribution is somewhat directional, the reflector 2 may be omitted. In this case, the light guide 3 suitably has a small size.

The light guide 3 is made of a transparent plate of a material such as quartz and glass or transparent resin such as acrylic resin and polycarbonate. The light guide 3 has a size equal to an object to be lighted. The back surface 3b of the light guide 3 forms an angle of about 90° with respect to the incident surface 3c of light from the light source 1. The light guide 3 has a generally tabular shape. A plurality of grooves are formed at the front surface 3a of the light guide 3 and guided light is totally reflected and deflected at the back surface 3b of the light guide 3. There is no anti-reflection film or no diffusion surface treatment provided to the back surface 3b of the light guide 3.

Reference numeral 4 denotes a reflective liquid crystal, which is widely used in image displays for office automation equipment such as a personal computer, a mobile information terminal and a portable video recorder and various other monitors.

A transparent material 5 is filled between the light guide 3 and the reflective liquid crystal 4 and contains no bubbles or foreign substance such as dust. The transparent material 5 may be for example an adhesive such as ultraviolet ray curing resin and visible light curing resin, or an adhesive tape of a transparent base such as PET coated with an adhesive.

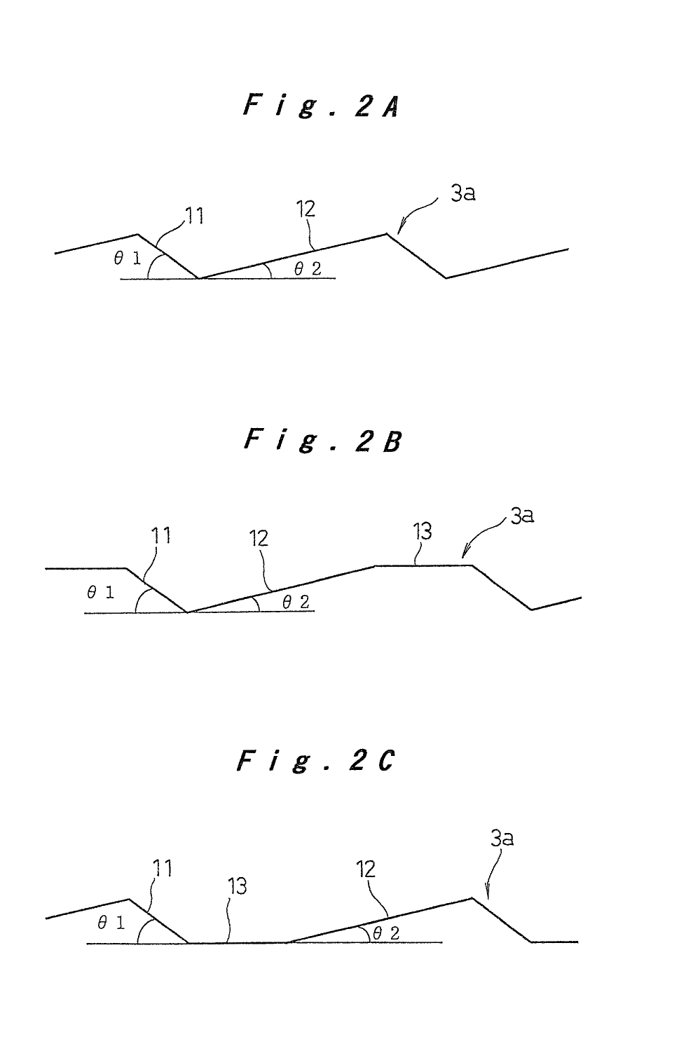

Examples of the shape of the grooves formed at the surface 3a of the light guide 3 are shown in FIGS. 2A to 2C. In the example shown in FIG. 2A, the groove is defined by a first inclined surface 11 and a second inclined surface 12. The angle θ1 formed by the first inclined surface 11 and the back surface 3b of the light guide 3 is set in the range from 30° to 45°. The angle θ2 formed by the second inclined surface 12 and the back surface 3b of the light guide 3 is set in the range from 0° to 10°. The angle θ1 determines the main direction in which the guided light is deflected by total reflection. Therefore, the angle θ1 at which the maximum luminance results varies depending on the reflection characteristic of the reflective liquid crystal 4. The depth of the grooves can be determined based on the angle θ2. As the reflective liquid crystal to be lighted is increased in size, the depth of the grooves may be decreased for equalized illumination. As the distance from the light source increases, the angle θ2 may be increased to increase the depth of the grooves for equalizing the luminance. Meanwhile, the angle θ2 may be increased and the pitch of the grooves may be reduced as the distance from the light source increases, so that the luminance can be equalized.

In the example shown in FIG. 2B, a flat surface 13 is formed between grooves, while in the example shown in FIG. 2C, a flat surface 13 is formed between the first inclined surface 11 and the second inclined surface 12. In these structures, the groove depth can be increased as the distance from the light source increases without changing θ2, so that the luminance can be equalized. Meanwhile, the groove pitch can be reduced as the distance from the light source increases without changing θ2, so that the luminance can be equalized. The shape shown in FIG. 2C is particularly preferable in that a mold having an inverted shape thereof can be readily produced.

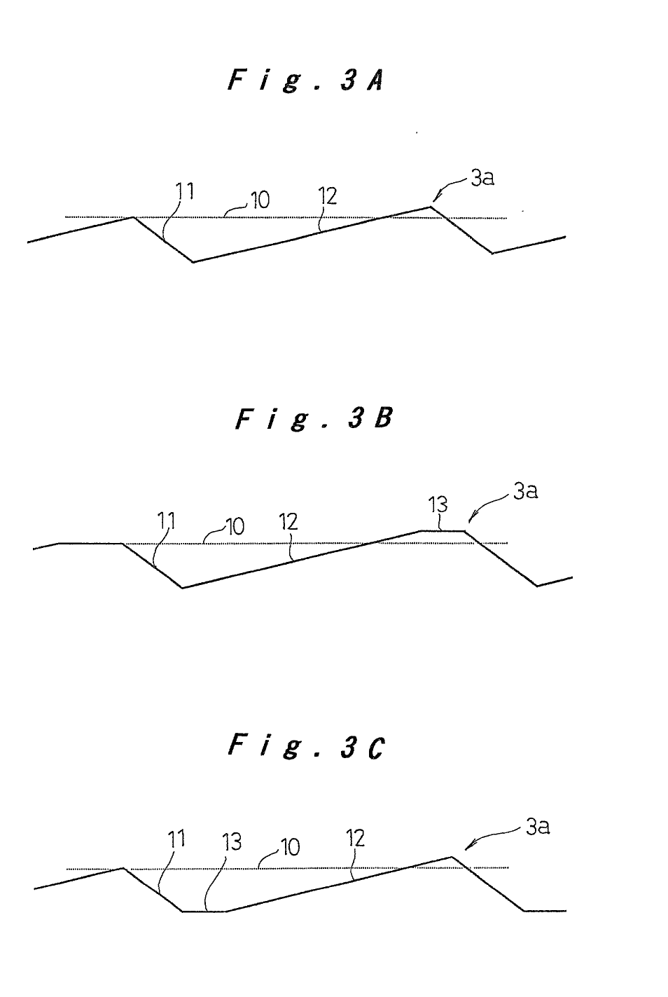

As shown in FIGS. 3A to 3C, the front surface 3a of the light guide 3 can be inclined such that its distance to the back surface 3b of the light guide 3 gradually increases toward the opposite side to the light source. More specifically, when the thickness of the light guide 3 at the side surface 3c on the light source side is t1, and the thickness at the side surface 3d on the side opposite to the light source is t2, t1≦t2 is established. In the figures, the reference numeral 10 represents a virtual line parallel to the back surface 3b of the light guide 3.

In the above described structure, since the space between the light guide 3 and the reflective liquid crystal 4 is filled with the transparent material 5, light guided through the light guide 3 is not totally reflected at the back surface 3b of the light guide 3 and the light directly reaches the reflective liquid crystal 4. Therefore, as compared to the structure without the filling of the transparent material 5 between the light guide 3 and the reflective liquid crystal 4, light propagates for a shorter distance. Meanwhile, the light guide 3 is generally formed into a tabular shape and t1≦t2 is established, so that the quantity of guided light directly reaching the reflective liquid crystal 4 can be smaller than the conventional stepped structure and equalized lighting can be achieved. The condition t1=t2 is basically sufficient, while t1<t2 is a condition more preferable to keep the luminance even more equalized. Also in this case, preferably the groove depth is increased and the groove pitch is reduced as the distance from the light source increases in order to further equalize the luminance.

Conversely, the front surface 3a of the light guide 3 may be inclined so that t1≧t2. In this case, the groove depth is decreased as the distance from the light source increases, so that the luminance is equalized. Alternatively, the groove pitch may be increased as the distance from the light source increases, so that the luminance is equalized.

The reflective liquid crystal 4 may have such a reflection characteristic that the diffusiveness is reduced for angles larger than the viewing angle θb. Thus, light incoming from the side surface 3c of the light guide 3 and directly reaching the reflective liquid crystal 4 can be propagated through the light guide 3, resulting in more uniform luminance.

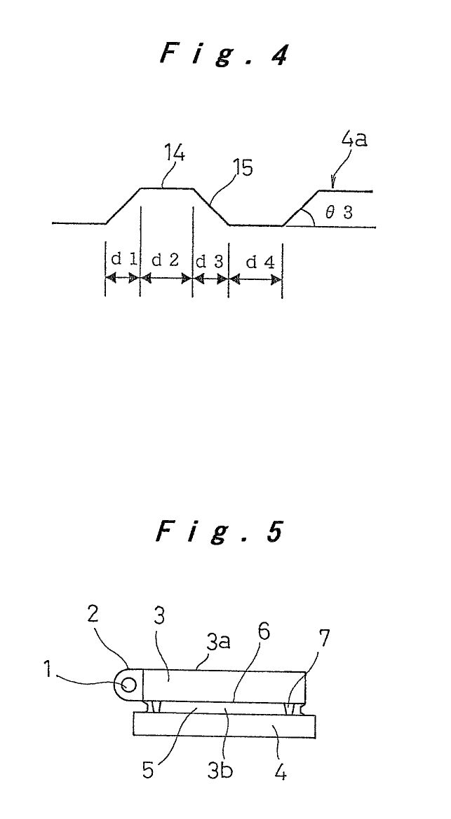

The reflective liquid crystal 4 may have such a reflection characteristic that light coming in at an angle equal to or larger than the viewing angle θb with respect to the normal line direction of the reflective liquid crystal 4 is reflected in an approximately vertical direction. Thus, if incoming light from the side surface 3c of the light guide 3 directly reaches the reflective liquid crystal 4, the front surface luminance can be improved and the luminance can be equalized as a result. Such a reflection characteristic is achieved by forming the reflection surface 4a of the reflective liquid crystal 4 to have a surface shape including a flat surface 14 and an inclined surface 15 at an angle θ3. The flat surface 14 and the inclined surface 15 are preferably diffusion surfaces. In FIG. 4, the main direction of the emitted light is determined based on the inclined angle θ3 of the inclined surface 15. The reflection light quantity of light at an angle of incidence greater than θb is determined based on d1 or d3, and the reflection light quantity of light at an angle of incidence smaller than θb is determined based on d2 or d4.

The glass transition temperature of the transparent material 5 filled between the light guide 3 and the reflective liquid crystal 4 is preferably smaller than the heat resisting temperature of the reflective liquid crystal 4. The material is thus heated to a temperature not less than the glass transition temperature of the transparent material 5 and not more than the heat resisting temperature of the reflective liquid crystal 4. Thus, the light guide 3 and the reflective liquid crystal 4 can be separated, which facilitates the reuse of the latter.

A reflective screen lighting device according to a second embodiment of the present invention embodied as a reflective liquid crystal lighting device will be described in conjunction with FIGS. 5 to 9A-9G. Note that the same elements as those in the first embodiment are denoted by the same reference characters and not detailed, while only the difference will be described.

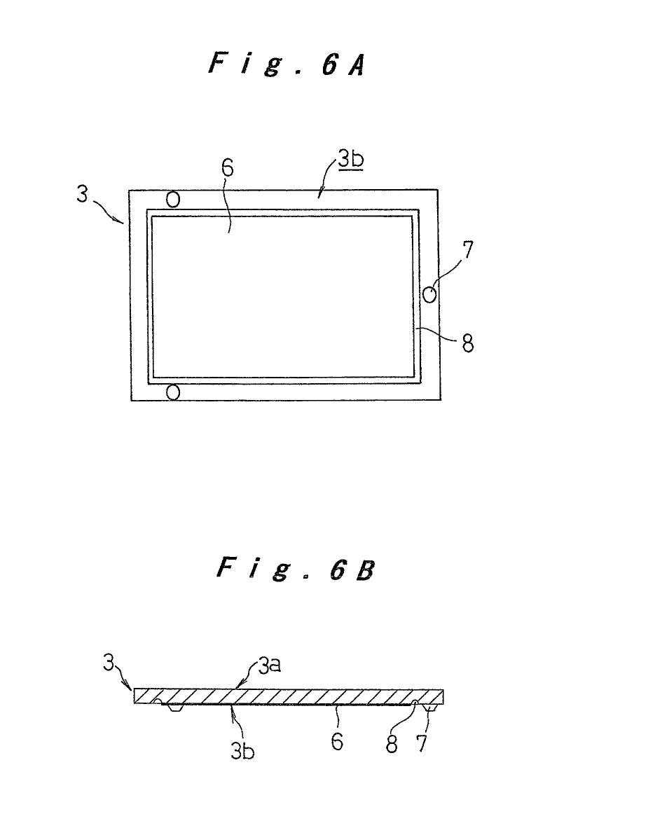

In FIGS. 5 and 6B, a thin film 6 is provided at the back surface of the light guide 3 by vapor deposition of various metal materials. A groove 8 is formed at the outer periphery of the part of the back surface 3b of the light guide 3 corresponding to the display portion of the reflective liquid crystal 4. The thin film 6 is formed on the inner side thereof, and at least three projections 7 are formed at the outer periphery outside the groove 8. The outer periphery of the light guide 3 refers to the range of about 1 mm from the outer peripheral edge of the light guide 3. The projection 7 has a height in the range from 0.05 mm to 2 mm and can be produced by adjusting the position of the ejection pin of the mold. Alternatively, the projection can be directly carved in the mold.

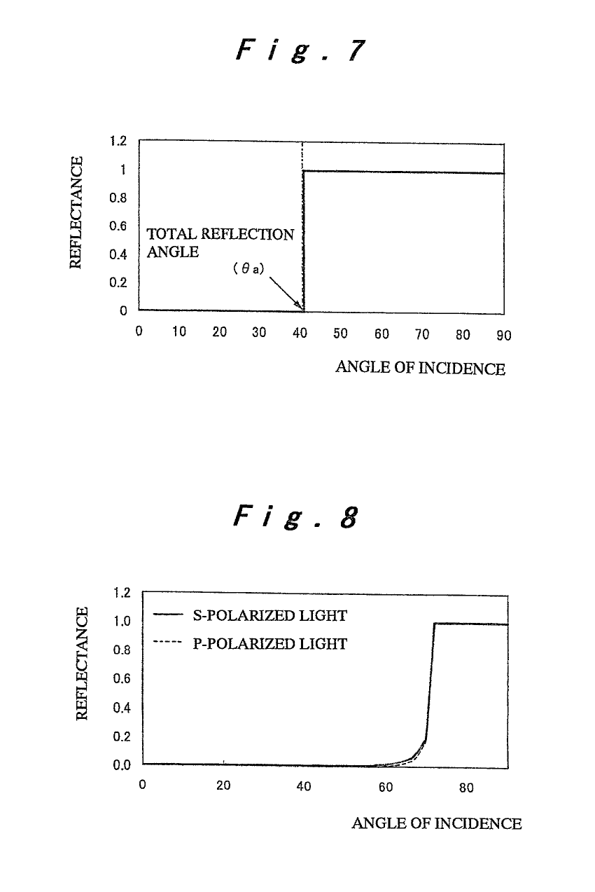

The characteristics required for the thin film 6 will be described. Illumination light by small grooves (prism) at the front surface 3a of the light guide 3 is reflected by the thin film 6 at the back surface 3b of the light guide 3, and lowers the contrast at the reflective liquid crystal 4. Therefore, when θa=sin⁻¹ (1/n) is established for the refractive index n of the light guide 3, the smaller the reflectance of light coming into the thin film 6 at an angle not more than the angle of incidence θa, the less lowered is the contrast at the reflective liquid crystal 4, which is a preferable condition. The higher the reflectance of the incident light at an angle not less than θa is, the more the light coming from the side surface of the light guide 3 can be reflected by the surface 3a of the light guide 3 and the thin film 6 at the back surface 3b. Therefore, the guided light can be propagated through the light guide 3. This improves the lighting efficiency and allows equalized lighting to be achieved. For these reasons, as shown in FIG. 7, the thin film 6 should be optimum if it allows the reflectance of the light coming in at an angle not more than θa to be 0% and the light coming in at an angle not less than θa to be 100%.

As a result, when θa=sin⁻¹ (1/n) is established for the refractive index n of the material of the light guide 3, light coming in at an angle not more than θa with respect to the normal line direction of the back surface 3b of the light guide 3 is transmitted through the thin film 6 almost entirely. Meanwhile, the film reflects light coming in at an angle in the range from θa to 90°. Therefore, the incoming light from the side surface 3c of the light guide 3 can propagate through the light guide 3 and the luminance can be equalized. The thin film 6 may be produced into a multi-layer film, so that the angle range of reflection can be wider and the luminance can be more equalized.

In order to achieve the characteristics similar to those described above, a material with a low refractive index may be selected as the transparent material 5 other than the use of the thin film 6. According to the method using the low refractive index material, reflection at the back surface 3b of the light guide 3 is determined based on the value of the total reflection angle θb represented by θb=sin⁻¹ (n′/n) where n is the refractive index of the light guide 3 and n′ is the refractive index of the transparent material 5. Therefore, the refractive index n′ of the transparent material 5 must be as small as possible in order to improve the lighting efficiency. For example, Zenore, polyolefine based resin (refractive index n=1.53) available from Zeon Corporation may be used as the material of the light guide 3. An adhesive for optical components (refractive index n′=1.45) available from NTT Advanced Technology Corporation may be used as the transparent material 5 with a low refractive index. At the time, the total reflection angle θb=71.4°. The total reflection angle θa by the light guide 3 and air is 40.8°, and therefore, light at an angle of incidence in the range from 40.8° to 71.4° directly comes into the reflective liquid crystal 4 without contributing to the lighting efficiency. FIG. 8 is a graph representing angle of incidence—reflectance relation when n=1.53 and n′=1.46. Note however that only a few kinds of transparent material 5 have a refractive index as low as this level. If any available, they are too expensive and therefore only a limited selection is provided.

The thin film 6 according to the embodiment includes a low refractive index material (L) having a thickness of λ/2 and a high refractive index material (H) having a thickness of λ/2 alternately arranged on each other. The thicknesses are both λ/2 so that the reflectance in the front surface direction is almost zero. The reflectance at a large angle of incidence may be raised based on the alternate combination of the low refractive index material and the high refractive index material. There are combinations of the low refractive index material and the high refractive index material as follows. The low refractive index material (L) and the high refractive index material (H) both have a thickness of λ/2.

(A) L

(B) L-H

(C) L-H-L

(D) L-H-L-H

(E) H-L

(F) H-L-H

(G) H-L-H-L

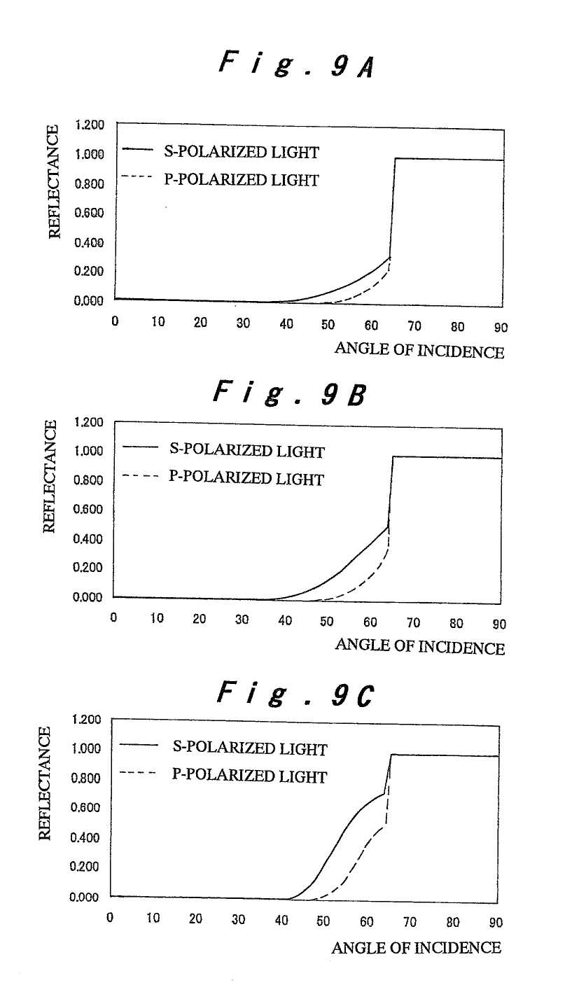

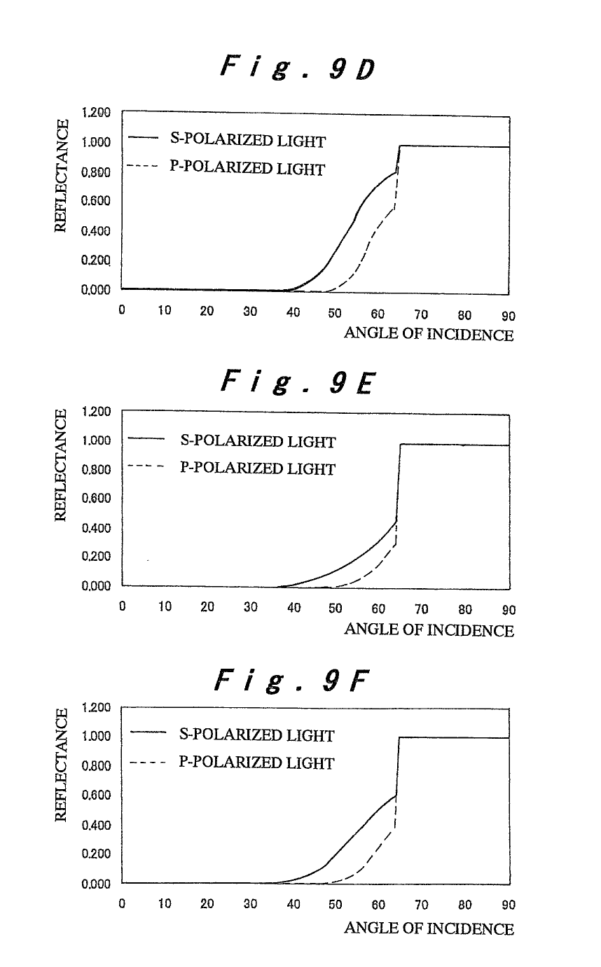

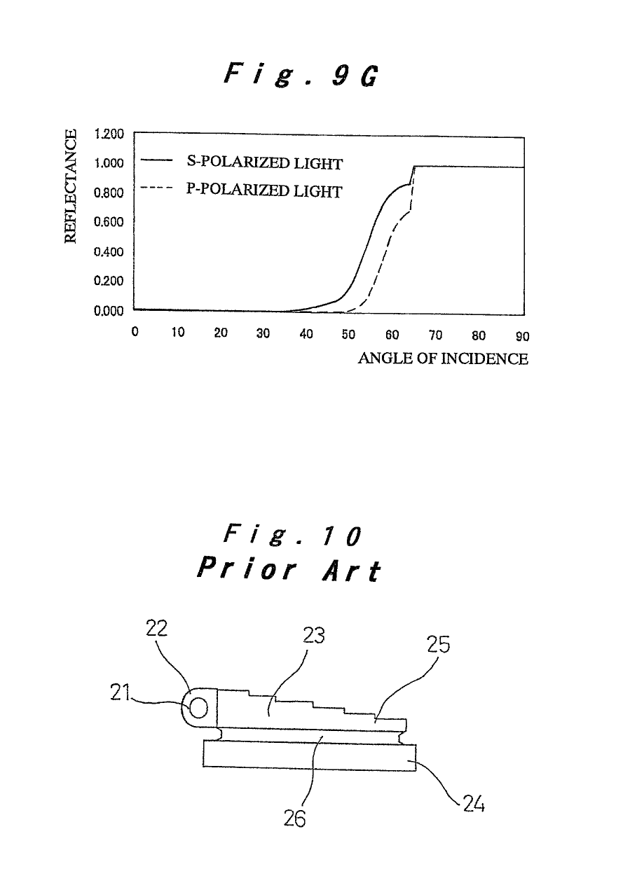

When MgF₂ (n=1.38) is used as the low refractive index material L, and Al₂O₃ (n=1.61) is used as the high refractive index material H, the relation between the angle of incidence and the reflectance is as represented by the graphs in FIGS. 9A to 9G. As can be seen from the graphs, the characteristics improve as the number of layers in thin film 6 increases. In the above example, the thin film has less than five layers, while the characteristics improve for a film having a larger number of layers. In practice, the number of layers increases the cost, and therefore the number may be determined in view of the cost and performance. For the low refractive index material, SiO₂ (n=1.46) may be used other than MgF₂. For the high refractive index material, SiO (n=2.0), ZrO₂ (n=2.01) or TiO₂ (n=2.30) may be used.

Note however that MgF₂ generally has poor adhesiveness to a resin material. Therefore, the low refractive index material in the first layer may preferably be made of SiO₂ to improve the adhesiveness of the thin film 6. As underlying layer treatment, SiO₂ may be vapor-deposited to be as thick as 10 to 20 nm in order to improve the adhesiveness of the thin film.

The manufacturing process will be now described. The reflective liquid crystal lighting device according to the embodiment is manufactured by the steps of producing reflective liquid crystal 4, producing a light guide 3, joining the light guide 3 and reflective liquid crystal 4, and incorporating a light source 1 thereinto. Among these process steps, the step of joining the light guide 3 and the reflective liquid crystal 4 will be now described.

First, foreign substances on the surface of the reflective liquid crystal 4 are removed. Then, a prescribed amount of a transparent material 5 is dropped at the central part of the surface of the reflective liquid crystal 4. The resulting pool of liquid is contacted with a light guide 3 from the top such that no bubble is let therein. The light guide 3 and the reflective liquid crystal 4 are adhered taking advantage of the surface tension of the surface of the reflective liquid crystal 4 and the back surface 3b of the light guide 3. Conditions for load and speed must be appropriately set or else the filling might not be provided on the entire surface or the transparent material 5 could come out depending upon the load applied at the time of the adhesion.

The conditions for the load and speed vary depending upon the wettability of the light guide 3, the reflective liquid crystal 4 and the transparent material 5. The higher the wettability, the smaller the load could be and the higher the speed could be. Conversely, for lower wettability, the load must be increased and the speed must be reduced, and therefore the manufacturing tact increases. The light guide 3 and the thin film 6 may be subjected to plasma ashing treatment to improve the wettability.

When the light guide 3 and the reflective liquid crystal 4 are adhered for joining, the thickness of the transparent material 5 tends to change, but the thickness can be constant using projections 7 formed at the back surface 3b of the light guide 3. The height of the projection 7 varies depending on the viscosity of the transparent material 5. For higher viscosity, the height of the projection 7 may be greater, while for lower viscosity, the height of the projection 7 can be smaller, so that the manufacturing tact can be reduced. In the examined ranges, about the range from 0.05 mm to 0.2 mm was the most appropriate. The shape of the projection 7 can be determined among circular, rectangular and elliptical shapes and the like based on the readiness associated with the manufacturing. The groove 8 provided at the outer periphery of the back surface 3b of the light guide 3 allows the transparent material 5 to be well controlled so as not to seep, which can reduce the manufacturing tact.

The reliability of the reflective liquid crystal lighting device according to the embodiment and a method of reusing the reflective liquid crystal 4 will be described. The reflective liquid crystal lighting device includes layers of different materials placed on one another, and therefore the materials having different expansion coefficients could become separated depending upon temperature changes. According to the embodiment, the thin film 6 is vapor-deposited only in the central part of the back surface 3b of the light guide 3 excluding the outer periphery thereof. Therefore, any transparent material 5 compatible with the light guide 3 and the reflective liquid crystal 4 can be selected for the outer periphery devoid of the thin film 6. This enhances the adhesion. If the outer periphery of the light guide 3 is cut off using a cutter or the like, the thin film 6 having low adhesiveness allows the light guide 3 to be readily removed. As a secondary effect, since the thin film 6 with low adhesiveness may be used, there is a wider selection of materials to choose from. Therefore, the reflective liquid crystal lighting device withstanding high temperature and humid conditions and allowing the reflective liquid crystal 4 to be reused can be implemented.

Note that in the above embodiments, the thin film 6 formed at the back surface 3b of the light guide 3 may be formed at the front surface of the reflective liquid crystal 4 and still the same effect results.

Furthermore, the lighting device according to the present invention may be applied to printing materials such as books and photographs.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A reflective screen lighting device, comprising:
a light source;
a tabular, transparent light guide having a front surface, a back surface, and a side surface and being provided for receiving light emitted from the light source at the side surface thereof and for emitting illuminating light from the back surface thereof;
a reflective liquid crystal for reflecting the illuminating light provided through the light guide; and
a transparent material filled between the back surface of the light guide and the reflective liquid crystal.

2. The reflective screen lighting device according to claim 1, wherein the front surface and the back surface of the light guide are substantially parallel to each other.

3. The reflective screen lighting device according to claim 1, wherein the distance between the front surface and the back surface of the light guide increases as the distance from the light source increases.

4. The reflective screen lighting device according to claim 3, wherein a plurality of grooves are formed at the front surface of the light guide, the groove including a first inclined surface on a side closer to the light source and a second inclined surface on a side further from the light source.

5. The reflective screen lighting device according to claim 4, wherein the depth of the grooves is increased as the distance from the light source increases.

6. The reflective screen lighting device according to claim 4, wherein the interval between the grooves is reduced as the distance from the light source increases.

7. The reflective screen lighting device according to claim 3, wherein a plurality of grooves and a flat surface between the grooves are formed at the front surface of the light guide, the groove including a first inclined surface on a side closer to the light source and a second inclined surface on a side further from the light source.

8. The reflective screen lighting device according to claim 7, wherein the depth of the grooves is increased as the distance from the light source increases.

9. The reflective screen lighting device according to claim 7, wherein the interval between the grooves is reduced as the distance from the light source increases.

10. The reflective screen lighting device according to claim 3, wherein a plurality of grooves are formed at the surface of the light guide, the groove including a first inclined surface on a side closer to the light source, a second inclined surface on a side further from the light source, and a flat surface.

11. The reflective screen lighting device according to claim 10, wherein the depth of the grooves is increased as the distance from the light source increases.

12. The reflective screen lighting device according to claim 10, wherein the interval between the grooves is reduced as the distance from the light source increases.

13. The reflective screen lighting device according to claim 1, wherein the distance between the front surface and the back surface of the light guide decreases as the distance from the light source increases.

14. The reflective screen lighting device according to claim 1, further comprising a layer of a material having a characteristic to reflect light coming in at an angle of more than θa with respect to a normal line of the back surface of the light guide, the layer being provided between the back surface of the light guide and the reflective liquid crystal, wherein θa=sin⁻¹ (1/n), where n is a refractive index of the light guide.

15. The reflective screen lighting device according to claim 14, wherein the layer is a thin film.

16. The reflective screen lighting device according to claim 15, wherein the thin film is made of a material having a refractive index smaller than n.

17. The reflective screen lighting device according to claim 16, wherein the material has a thickness of λ/2, where λ is a wavelength in a visible light region.

18. The reflective screen lighting device according to claim 15, wherein the thin film is a multi-layer film including a layer of a material having a refractive index smaller than n and a layer of a material having a refractive index larger than n, these layers being alternately layered upon one another.

19. The reflective screen lighting device according to claim 18, wherein the material has a thickness of λ/2, where λ is a wavelength in a visible light region.

20. The reflective screen lighting device according to claim 15, wherein the thin film is provided at the back surface of the light guide excluding the outer peripheral portion thereof.

21. The reflective screen lighting device according to claim 1, wherein the reflective liquid crystal has a reflection characteristic such that light coming in at an angle of θb or less with respect to a normal line of the reflective liquid crystal has higher diffusiveness than that of light coming in at an angle of more than θb , where θb is a viewing angle at the reflective liquid crystal.

22. The reflective screen lighting device according to claim 1, wherein the reflective liquid crystal has a reflection characteristic such that light coming in at an angle of more than θb with respect to a normal line of the reflective liquid crystal is reflected in a substantially vertical direction, where θb is a viewing angle at the reflective liquid crystal.

23. The reflective screen lighting device according to claim 1, wherein the light guide is provided with a projection having a height in the range from 0.05 mm to 0.2 mm at the back surface thereof.

24. The reflective lighting device according to claim 1, wherein the light guide is provided with a groove at the outer periphery of the back surface thereof.

25. The reflective screen lighting device according to claim 1, wherein the transparent material has a glass transition temperature equal to or less than a heat resisting temperature of the reflective liquid crystal.
